(19) United States
(12) Patent Application Publication
(10) Pub. No.: US 2010/0318353 A1
(43) Pub. Date: Dec. 16, 2010

(54) COMPRESSOR AUGMENTED ARRAY PROCESSING

(76) Inventor: Karl M. Bizjak, Orinda, CA (US)

Correspondence Address: PILLSBURY WINTHROP SHAW PITTMAN LLP, P.O. BOX 10500, MCLEAN, VA, 22102, US

(21) Appl. No.: 12/816,932

(22) Filed: Jun. 16, 2010

Related U.S. Application Data
(60) Provisional application No. 61/187,583, filed on Jun. 16, 2009.
(60) Provisional application No. 61/320,593, filed on Apr. 2, 2010.

(51) Int. Cl. G10L 15/00; G06F 17/00

(52) U.S. Cl. 704/231; 700/94; 704/E15.001

(57) ABSTRACT

The present invention relates generally to the use of compressors, with an optional noise extractor, to improve audio sensing performance of one or more microphones. The audio sensing performance of a single element microphone array with dynamic range compression can be improved by the use of a noise extractor, to modify the operation of the compressor, typically to avoid noise floor amplification. Dynamic range compression can be applied to the output of two or more element microphone array processing with the optional use of a noise extractor. Dynamic range compression can precede the microphone array processing with the optional use of a noise extractor. Syllabic dynamic range compression may be used in one or more element microphone arrays, with the optional use of a noise extractor, which increases speech recognition accuracy.

### CROSS-REFERENCE TO RELATED APPLICATIONS

The present Application claims priority from U.S. Provisional Patent Application No. 61/187,583 filed Jun. 16, 2009 and from U.S. Provisional Patent Application No. 61/320,593, filed Apr. 2, 2010, which applications are expressly incorporated by reference herein for all purposes.

### BACKGROUND OF THE INVENTION

1. Field of the Invention

The present invention relates generally to signal processing and more specifically to signal processing systems that use dynamic range compressors.

2. Description of Related Art

The sensitivity of microphones decreases dramatically with increasing distance between the audio source and the microphone. Automatic Gain Control (AGC) processing of the microphone output has been used to increase the microphone output level of distant low level sounds (see FIG. 1). This results in amplification of low-level noise, both acoustic and electronic, which is annoying to people, which consumes bandwidth, and which interferes with speech recognition and other applications. An additional problem frequently occurs where the acoustic background noise level often varies. To reduce the background noise level, microphone arrays may be used (see FIG. 2), although such arrays can be much more costly to manufacture. However, microphone arrays are also subject to the reduction of microphone sensitivity with increasing distance to the source.

Microphone output may be input to a speech recognition system to process voice commands and for text input. Current speech recognition systems and methods fall short of 100% accuracy, which is of paramount importance for widespread acceptance and use. Significant decreases in accuracy are due to the large amplitude difference between loud speech sounds (vowels) and soft speech sounds (consonants), which difference can be as high as 30 dB. The soft speech sounds are of critical importance to differentiate words, yet speech recognition systems generally have trouble processing these low level sounds. For example, “cat” is recognized as “cap” and “bat” as “at.” Special attention to word enunciation is critical, placing the burden of high accuracy speech recognition on the user. Background noise also affects accuracy by reducing the speech signal to noise ratio.

FIG. 3 shows a prior art speech recognition system consisting of a microphone supplying an audio signal to a computer or digital signal processor system performing speech recognition. FIG. 4 shows an improved but more expensive prior art speech recognition system using a microphone array to increase the signal to noise ratio of the speech signal. In the prior art systems of FIGS. 3 and 4, the microphone gain is typically set during a training session, where the user speaks a few sentences containing plosive sounds that tend to produce the highest pressure sound waves at the microphone. The gain is set to avoid clipping and a consistent average microphone output level and consistent speech waveform amplitudes result for as long as the headset microphone is in the same position for speech recognition sessions, thereby maintaining the original speech recognition accuracy. However, a desktop microphone cannot provide the consistency required for high accuracy and microphone arrays or headset microphones are used to attempt to correct the deficiency.

### BRIEF SUMMARY OF THE INVENTION

Certain embodiments of the invention provide signal processing systems. In certain embodiments, the signal processing systems employ dynamic range compressors and/or an optional noise extractor. The systems may be used to improve audio sensing performance of various classes of devices comprising, for example, a microphone system comprising one or more microphones that may be used in applications that include wireless and wired communications, gaming, recording, robotics, automatic speech recognition, location sensing and so on.

The use of audio compressors, syllabic compressors with fast attack and release times, multiband techniques, one or more microphones, and a background noise floor extraction system can significantly improve the basic microphone response. According to certain aspects of the invention, dynamic range compression and a background noise extractor may be used to improve the performance of a single element microphone array. Dynamic range compression can not only extend the useful range of the microphone by amplifying the low level or distant sounds but can also help reduce low level noise amplification. When combined with a background noise floor extractor, compressor operating parameters, such as kneepoints, gain and gain slopes, may be automatically altered to optimally avoid amplifying the noise floor. Such dynamic range compression and background noise extractor can be applied to multiband compression techniques, where the input signal is divided into a plurality of frequency bands, and each frequency band is further processed by a compressor. Advantageously, only the compressors in bands containing noise may be selectively adjusted, since noise is not necessarily wideband. A further advantage is obtained in speech recognition because vowels (lower frequencies) can be separated from consonants (higher frequencies) for improved recognition accuracy.

According to certain aspects of the invention, a compressor or multiband compressors may be used to process the output of a microphone array. The useful range of the microphone array can be extended by amplifying low level or distant sounds and the effects of low level noise amplification can be reduced. When used with a background noise floor extractor, compressor operating parameters may be automatically altered to best avoid amplifying the noise floor, as described above.

According to certain aspects of the invention, a compressor or multiband compressors can be used to process the output of each microphone in an array. Low level or distant sounds can be amplified for more accurate processing of the array microphone inputs. Time delays may be added to steer the array beam or electrically increase the distance between microphone elements to narrow the beamwidth at lower frequencies. When used with a background noise floor extractor, compressor operating parameters may be automatically altered to best avoid amplifying the noise floor, as described above.

According to certain aspects of the invention, syllabic compression may be substituted for one or more compressors and multiband compressors. Use of a compressor with fast attack and release times permits syllabic compression, amplifying the soft speech sounds (primarily consonants), allowing increased speech intelligibility and easier speech recognition processing and increased accuracy. A second issue affecting accuracy is providing consistent overall speech waveform amplitudes. This typically requires the use of a headset microphone in close proximity to the speaker's mouth. Use of dynamic range compression can provide a constant overall microphone output and speech waveform amplitudes, removing the constraint of using a headset microphone for best performance. Syllabic compression combined with a background noise floor extractor can avoid sending amplified noise into the speech recognition processor and reduce the bandwidth of wireless and IP communications. Further, the use of multiband techniques (bandsplit filters and associated compressors) may be used to separate the vowels (lower frequencies) from the consonants (higher frequencies) for improved syllabic compression. Any of the previously mentioned techniques may be implemented in a microphone array.

### BRIEF DESCRIPTION OF THE DRAWINGS

FIG. 1 shows a prior art AGC system using a single microphone.

FIG. 2 shows a prior art microphone array.

FIG. 3 shows a prior art speech recognition system using a single microphone.

FIG. 4 shows a prior art speech recognition system using a microphone array.

FIG. 5 shows a comparison of compression limiting versus dynamic range compression.

FIG. 6 shows an example of dynamic range compressor operating parameters.

FIG. 7 shows one example of the behavior of dynamic range compressor and noise floor extractor.

FIG. 8 shows an example of a compressor with noise floor extractor.

FIG. 9A shows an example of a multiband compressor and noise floor extractor.

FIG. 9B shows an example of a multiband compressor and noise floor extractors.

FIG. 10 shows an example of a microphone array processor with additional processing by a compressor or multiband compressor with optional noise floor extractor.

FIG. 11 shows an example of a multi-compressor microphone array where each microphone output is processed by a compressor.

FIG. 12 shows an exemplary multi-compressor microphone array with a noise floor extractor.

FIG. 13A shows an example of a multiband compressor microphone array.

FIG. 13B shows details of one example of a multiband compressor block.

FIG. 14A shows an example of a multiband, multi-compressor microphone array and noise floor extractor.

FIG. 14B shows an example of a multiband, multi-compressor microphone array and noise floor extractor.

FIG. 15 shows an example of a speech recognition system using a single microphone and syllabic compressor provided to the speech recognition processor and audio output.

FIG. 16 shows an example of a speech recognition system using a single microphone and multiband syllabic compressor provided to the speech recognition processor and audio output.

FIG. 17 shows an example of a speech recognition system using a microphone array processing output processed by a syllabic compressor and input to the speech recognition processor and audio output.

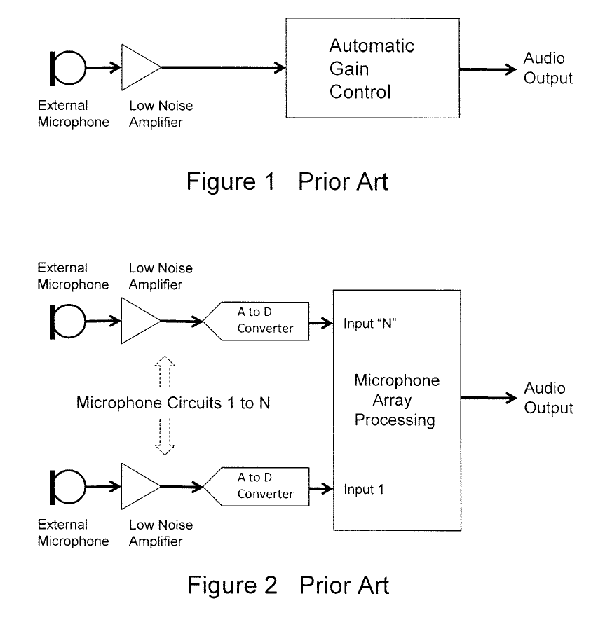

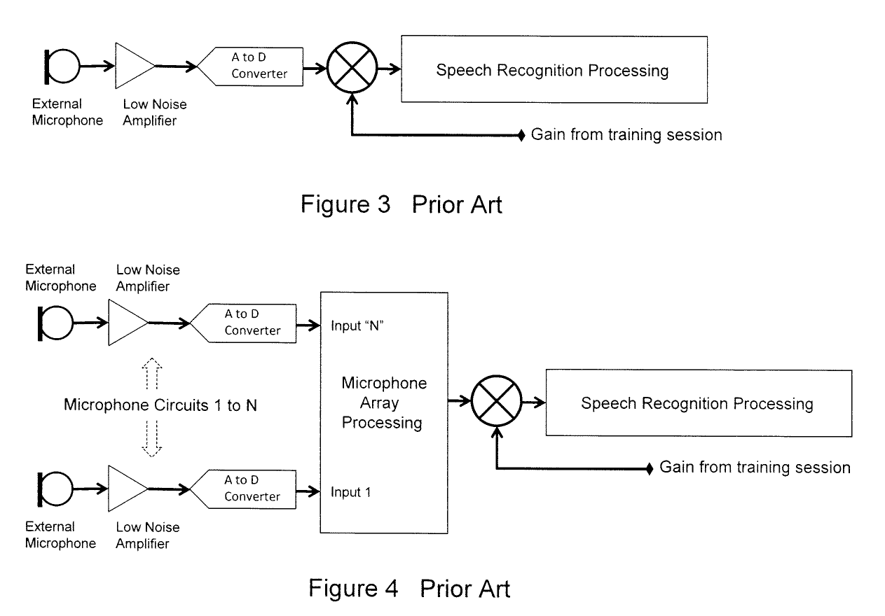

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration. In the descriptions of certain embodiments below, the term “compressor” is intended to encompass and include “syllabic compressor.”

Certain embodiments and examples described herein employ systems, apparatus, methods, components and elements described in U.S. Pat. No. 7,558,391, filed Nov. 29, 2000, entitled Compander Architecture and Methods, pending U.S. patent application Ser. No. 09/728,215, filed Nov. 29, 2000, entitled “NOISE EXTRACTOR SYSTEM AND METHOD”, and pending U.S. patent application Ser. No. 12/018,765 filed Jan. 23, 2008, entitled “Noise Analysis and Extraction Systems and Methods,” all of which are incorporated herein in their entirety.

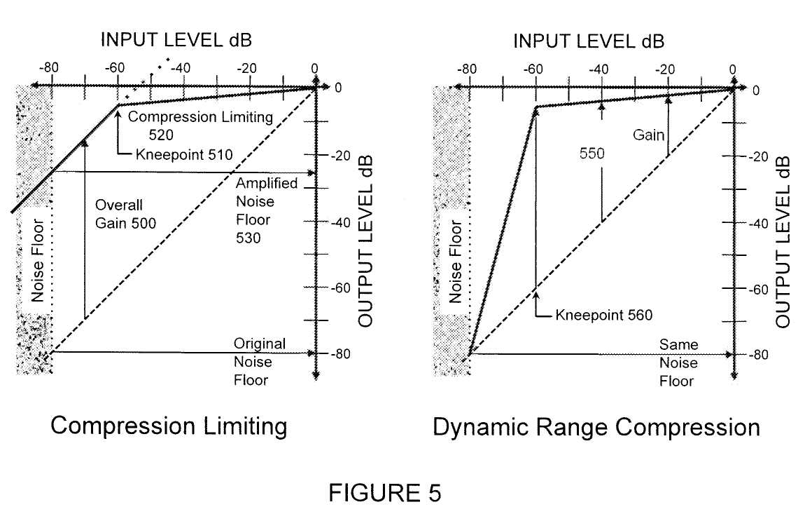

FIG. 5 illustrates the difference in operation of a compression limiter and dynamic range compression. Compression limiting, shown on the left side of the drawing, first amplifies the signal by Overall Gain 500 and then reduces the gain above Kneepoint 510, thus amplifying the noise floor resulting in Amplified Noise Floor 530. Dynamic range compression applies a variable amount of gain based on the input signal level, resulting in an unmodified or attenuated noise floor level. Note that a compression limiter with an expansion segment instead of a linear gain segment below Compression Limiting segment 520 and Kneepoint 510 can emulate a dynamic range compressor and is thus considered equivalent for the purposes of this discussion.

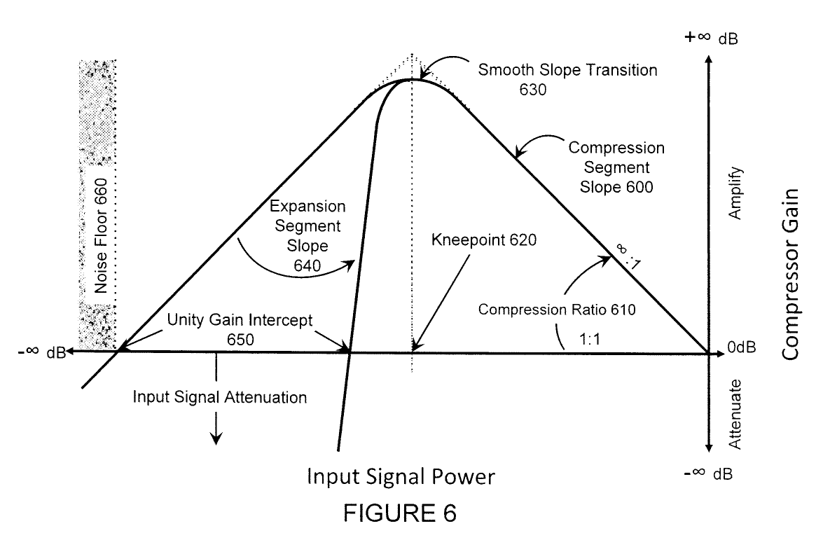

FIG. 6 depicts, as an example, typical compressor or multiband compressor operating parameters that may be adjusted to modify compressor operation and response, for example, by a noise floor detector. Compression Segment Slope 600 is typically determined by Compression Ratio 610 which is typically greater than 1:1 (unity gain) but not more than ∞:1 (constant output amplitude). Input signal power levels below Kneepoint 620 encounter reduced gain in Expansion Segment Slope 640, the slope typically set by an expansion ratio. The expansion slope determines the Unity Gain Intercept 650 input signal power level below which the input signal is attenuated. This results in the Noise Floor 660 being unamplified or attenuated. Conversely, Unity Gain Intercept 650 may set the expansion slope and expansion ratio. To avoid signal distortion, the transition from compression to expansion is rounded, as show by Smooth Slope Transition 630. Note that there may be multiple compression or expansion segments and associated kneepoints and compression/expansion ratios, as well as an overall gain offset associated with the entire gain curve, all of which may be adjusted and which can be considered additional compressor or multiband compressor operating parameters. Certain embodiments, such as microphone arrays, include a delay buffer to steer the beam and/or to electrically increase the distance between microphone elements to produce a narrower beam. This delay buffer may be distinct from the compressor or incorporated into the compressor, an example of which is described in U.S. Pat. No. 7,558,391. In certain embodiments, the FIFO buffer size, circular buffer size, or time delay parameters are adjusted to vary the amount of delay, all of which will be considered additional compressor or multiband compressor operating parameters.

System Operating Parameters typically include the Compressor or Multiband Compressor Operating Parameters, Noise Floor Extractor Operating Parameters, and Bandsplit Filter Operating Parameters. The System Operating Parameters may include the base or initial Compressor or Multiband Compressor Operating Parameters or Bandsplit Filter Operating Parameters which can then be modified by one or more Noise Floor Extractors to control compressors and bandsplit filters. Bandsplit Filter Operating Parameters may include the number of frequency bands, the boundary frequencies of the bands, bandwidth of each band, and a gain for each band. Noise Floor Extractor Operating Parameters may include a noise floor to unity gain intercept offset, noise floor to one or more kneepoint offsets, attack and release rates for responding to noise floor changes, and the response algorithm.

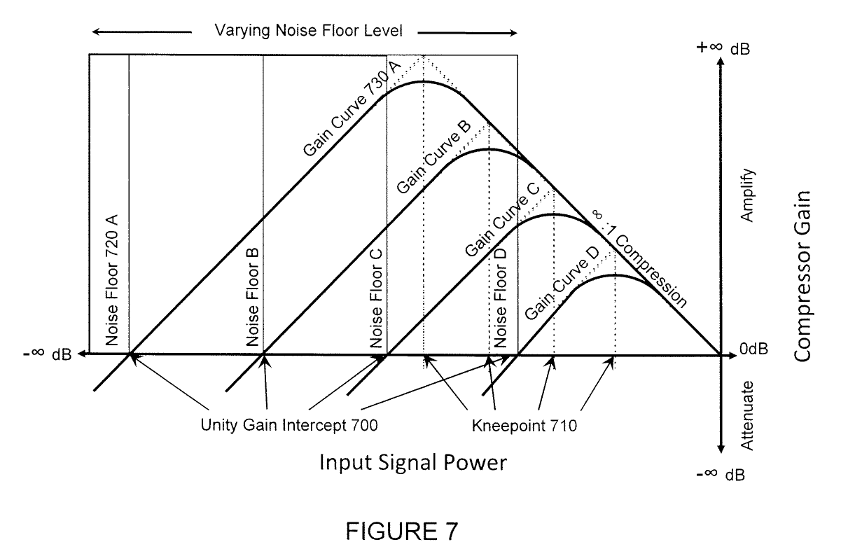

FIG. 7 depicts an example of a noise floor extractor that can modify the compressor response. An example of a noise floor extractor is further described in pending U.S. patent application Ser. No. 12/018,765 filed Jan. 23, 2008, entitled “Noise Analysis and Extraction Systems and Methods.” Here the response algorithm to noise floor changes in the extractor (Noise Floor 720 A-D) moves the Unity Gain Intercept 700 (UGI) and Kneepoint 710 to the right when the noise floor increases (A to D) and to the left when it decreases (D to A). This allows automatic compressor adjustment for noise floor changes as shown by the modified Gain Curves 730 A-D, which maintain the UGI at the noise floor level. Other compressor adjustment response algorithms are possible, for example, moving the UGI to the right until the expansion slope reaches a maximum limit, at which point both the UGI and the kneepoint are moved and the reverse, where both the UGI and kneepoint are moved to the left until the initial kneepoint setting is reach, whereupon only the UGI is moved to the left. For compressors with more than one compression or expansion segment, one or more associated kneepoints may be adjusted. In addition, the UGI may be higher than the noise floor, resulting in the attenuation of the noise floor. Conversely, the UGI may be lower than the noise floor, allowing some of the noise floor to be passed.

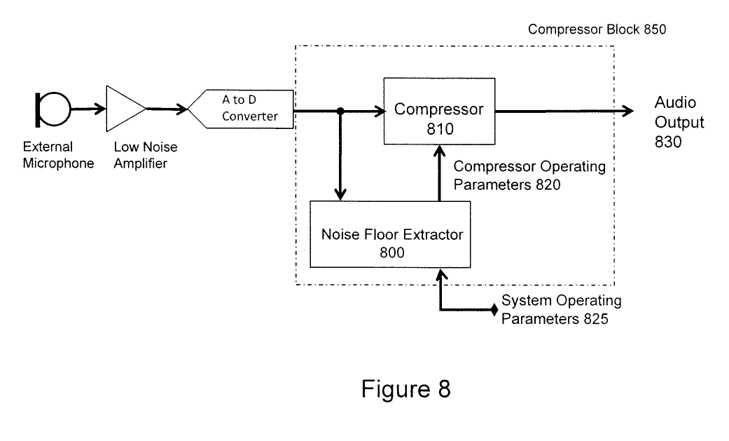

FIG. 8 shows an example of a compressor with noise floor extractor. A feed-forward implementation is shown in which the input signal to Compressor 810 is also the input to Noise Floor Extractor 800, which can adjust Compressor Operating Parameters 820 in response to noise floor changes. System Operating Parameters 825 typically provide the initial or base Compressor Operating Parameters to Noise Floor Extractor 800 for modification into Compressor Operating Parameters 820, which are provided to Compressor 810. Note that a feedback implementation may be used where Audio Output 830 is used as the input to Noise Floor Extractor 800.

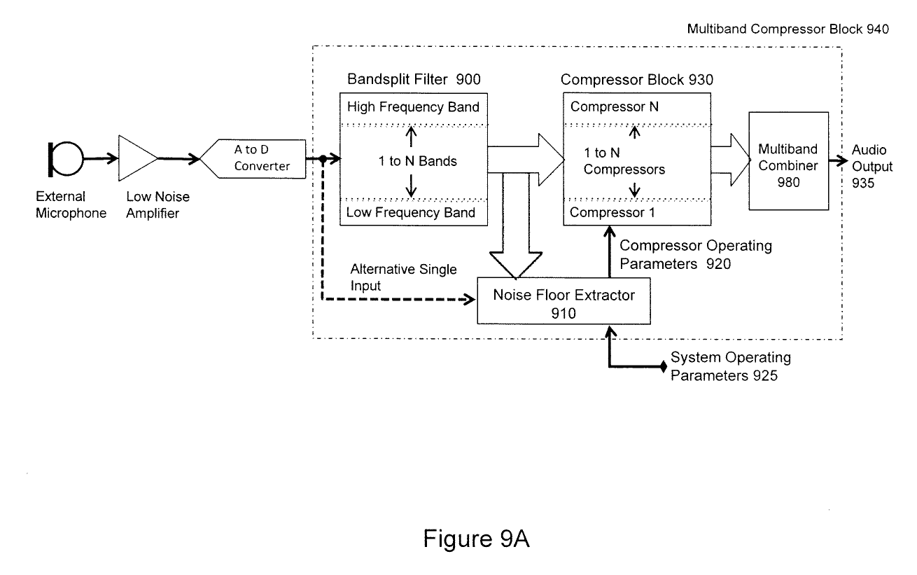

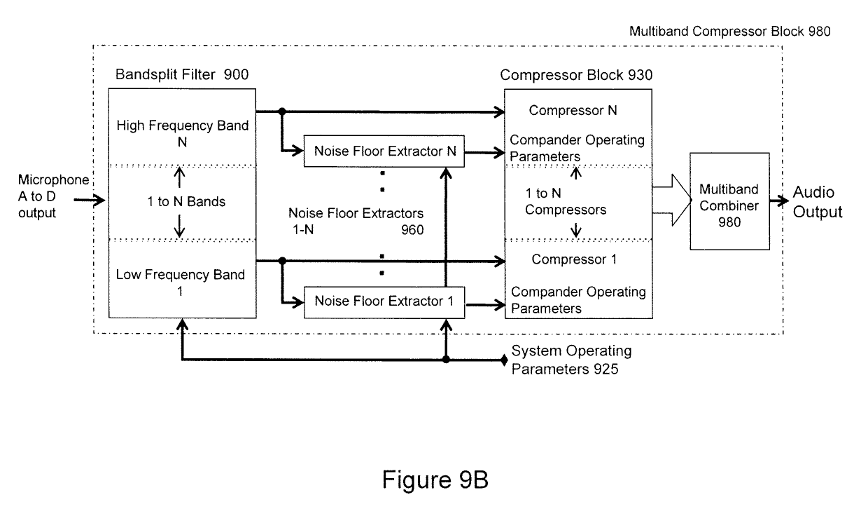

Certain embodiments may incorporate a bandsplit filter where each band output is provided to an associated compressor. Two examples are shown in FIGS. 9A and 9B. In FIG. 9A, the outputs of Bandsplit Filter 900 are provided to Noise Floor Extractor 910, producing Compressor Operating Parameters 920, typically responding to the noisiest bandsplit filter output, which is supplied to at least one of the compressors in Compressor Block 930, the outputs of the compressor block provided as inputs to Multiband Combiner 980 to produce one Audio Output signal 935. Alternatively, the input to the bandsplit filter may be provided to Noise Floor Extractor 910 although the nose floor is typically higher since the noise is not spread among many bands. Feedback designs may be used in which case Compressor Block 930 outputs or the Audio Output 935 are used as the input to Noise Floor Extractor 910. Note that not all Bandsplit Filter 900 outputs need to be provided as inputs to Noise Floor Extractor 910 or processed by an associated compressor in Compressor Block 930, in which case the bandsplit filter outputs are provided directly as inputs to Multiband Combiner 980. System Operating Parameters 925 provide the initial or base Compressor or Multiband Compressor Operating Parameters to Noise Floor Extractor 910, which may be different for each compressor, the same for all compressors, or consist of common subsets, where a plurality of compressors have the same compressor operating parameters. The initial or base Compressor or Multiband Compressor Operating Parameters may be modified by Noise Floor Extractor 910 to produce Compressor Operating Parameters 920 that are modified in the same manner or differently for each compressor or subset of compressors.

The background noise level typically varies with frequency and it may therefore be desirable to have a noise floor extractor for each band/compressor so that only the bands containing noise are adjusted. FIG. 9B depicts such an example. Each output “N” of Bandsplit Filter 900 is provided as a signal input to noise floor extractor “N” of Noise Floor Extractors 960 and associated compressor “N” in Compressor Block 930 while the noise floor extractor provides Compressor Operating Parameters to the associated compressor. Feedback designs may be used in which case the output of compressor “N” of Compressor Block 930 is used as the input to the associated noise floor extractor “N” of Noise Floor Extractors 960. Note that not all Bandsplit Filter 900 outputs need be provided as inputs to Noise Floor Extractors 960 or processed by an associated compressor in Compressor Block 930, in which case the bandsplit filter outputs are provided directly as inputs to Multiband Combiner 980.

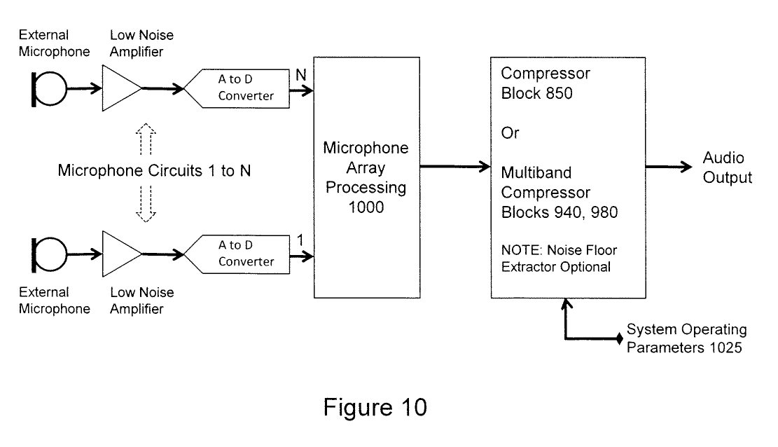

To increase the distance from the audio source to the microphone, microphone array beam forming may be used to increase the audio source signal to noise ratio by reducing the amount of background noise detected away from the audio source. One example of a microphone array is shown in FIG. 10, where the output of Microphone Array Processing 1000 is further processed by Compressor Block 850 or Multiband Compressor Blocks 940 or 980. Since the array already reduces background noise, the Noise Floor Extractors in blocks 850, 940 or 980 may not be required and are accordingly optional. System Operating Parameters 1025 typically contains Compressor or Multiband Compressor Operating Parameters, Noise Floor Extractor Operating Parameters, and Bandsplit Filter Operating Parameters as previously discussed.

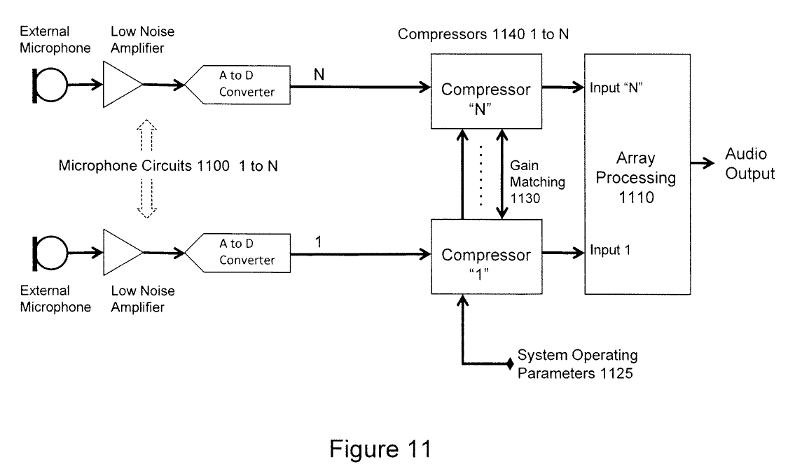

A more effective array can be realized by processing each microphone output through a compressor, as shown in the example of FIG. 11. Each of the 1 to N Microphone Circuits 1100 outputs is further processed by an associated compressor, the outputs of which are then provided to Array Processing 1110 for beamforming calculations. Low level sounds are thus amplified, which improves beam forming processing in the array processor for low level sounds. Note that not all of the 1 to N Microphone Circuits 1100 outputs need be processed by an associated compressor. For example, some Microphone Circuits 1100 outputs may be provided directly to Array Processing 1110, providing near and loud sound inputs, while others are further processed by compressors, providing far and soft sound inputs, to obtain, for example, a distance estimate to the sound source. Typically, a compressor is used that has a constant group delay or linear phase response, which does not modify the phase of the received microphone signals. In certain embodiments, the compression gain of two or more compressors is linked or matched via Gain Matching 1130 in order to maintain the relative amplitude relationships among the microphones. Any unintended change in delay or amplitude may inadvertently steer the array beam away from the desired direction, although in some cases this is intentional and desirable: for example, it may be desirable to follow a moving speaker or to electrically modify the distance between microphone elements to change the beamwidth. System Operating Parameters 1125 supply the initial or base Compressor Operating Parameters, which may be different for each compressor, the same for all compressors, or comprise common subsets, where a plurality of compressors have the same compressor operating parameters, and which may include delay parameters to vary the amount of delay. An example of such a compressor with adjustable constant group delay and gain linkage is described in U.S. Pat. No. 7,558,391

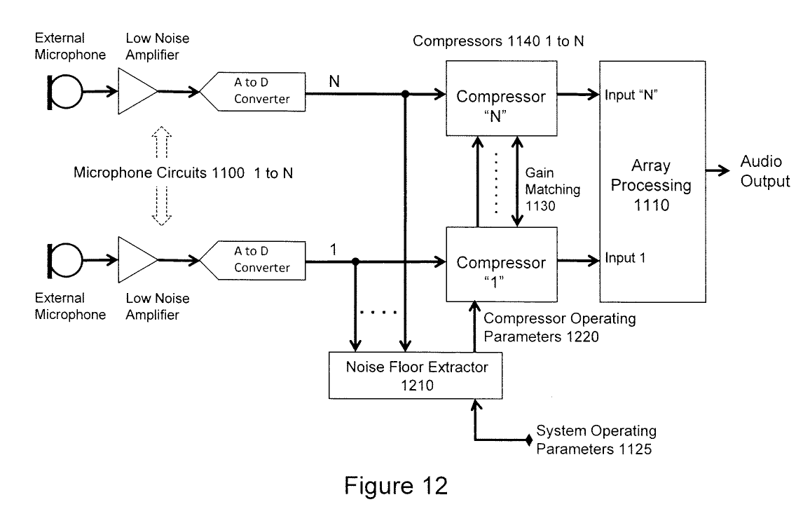

The example in FIG. 12 shows an optional noise floor extractor for compressor control may be added to the previously described implementation. Each of the 1 to N Microphone Circuits 1100 outputs is provided as an input to Noise Floor Extractor 1210. In this example, the noise floor is typically based on the microphone with the highest noise floor. System Operating Parameters 1125 provide the initial or base Compressor Operating Parameters to Noise Floor Extractor 1210, which may be different for each compressor, the same for all compressors, or may comprise common subsets, where a plurality of compressors have the same compressor operating parameters. The initial or base Compressor Operating Parameters may be modified by Noise Floor Extractor 1210 to produce Compressor Operating Parameters 1220 that are modified in the same manner or differently for each compressor or subset of compressors. Noise Floor Extractor 1210 modifies at least one of the 1 to N compressors, although typically the operation of all 1 to N compressors is modified equally to avoid any gain mismatch among the compressors that might inadvertently steer the array beam away from the desired direction. Alternatively, each compressor could have an associated noise floor extractor but this may also inadvertently steer the array beam away from the desired direction and result in a less cost-effective solution. In this example, System Operating Parameters 1125 typically include the Compressor Operating Parameters, including any delay parameters, and Noise Floor Extractor Operating Parameters. For a feedback implementation, the outputs of Compressors 1140 1 to N may be used as inputs to Noise Floor Extractor 1210. Note that not all of the 1 to N Microphone Circuits 1100 outputs or Compressors 1140 outputs need be provided to Noise Floor Extractor 1210. Also note that, in certain embodiments, the outputs of one or more of the Microphone Circuits 1100 may bypass compressor processing and be directly input to Array Processing 1110.

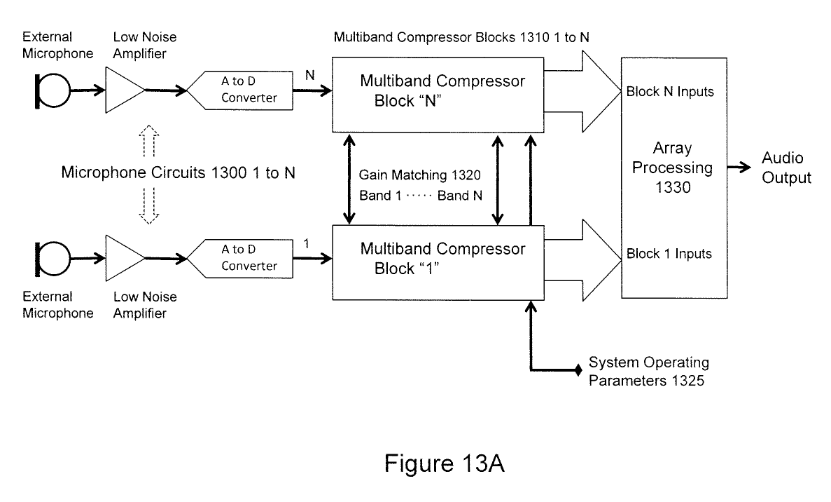

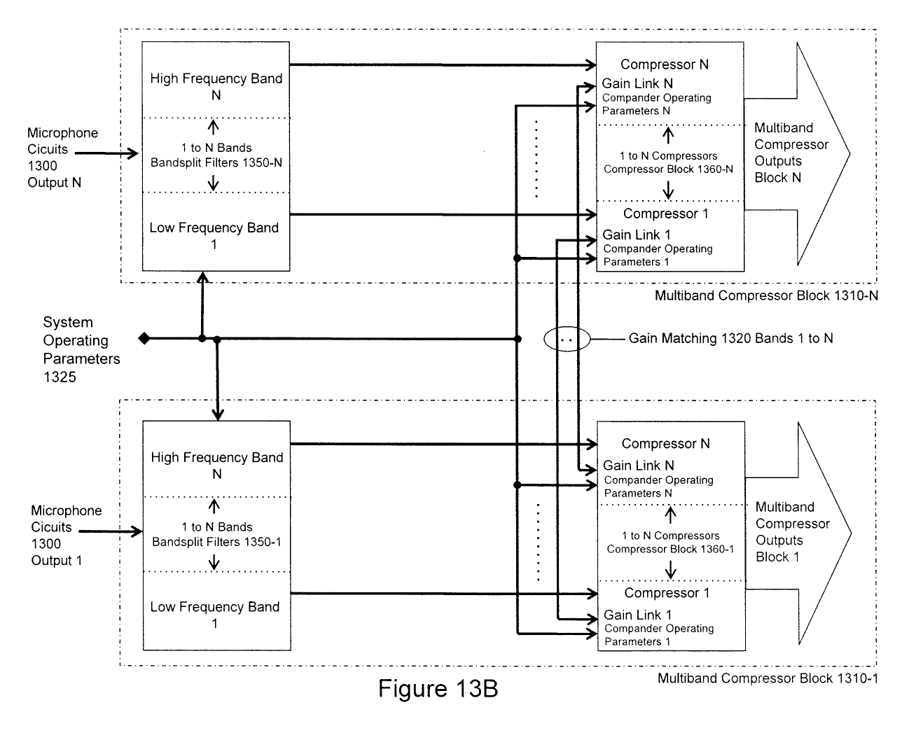

FIG. 13A shows an example of a microphone array where each microphone output is processed by a Multiband Compressor Block, which comprises a bandsplit filter, with the output of each band being provided to an associated compressor. Since the microphone spacing in the array is typically fixed, there is less of a phase difference at lower frequencies resulting in wider beamwidths. By providing multiple frequency bands, the lower frequency bands can be further processed by increasingly longer delay lines, which electrically increases the microphone distance for lower frequencies producing narrower beamwidths. The delay lines are typically included in the Array Processing 1330 but can be included in the compressor. In FIG. 13A, each of the 1 to N Microphone Circuits 1300 outputs is further processed by an associated Multiband Compressor Block 1310 1 to N. Details of the multiband compressor blocks and their interconnections will be discussed further in connection with the example shown in FIG. 13B. Note that Array Processing 1330 typically processes each frequency band from every Multiband Compressor Block as an independent array and then combines the band-array outputs to produce a single output. Typically, the gain and group delay for all compressors in each band are linked or matched to avoid inadvertently steering the array beam away from the desired direction, although all of the compressors in all bands may be linked or matched. Gain Matching 1320 links, Bands 1 to N, illustrates the gain matching between the common bandsplit filter frequency bands distributed among Multiband Compressor Blocks 1310 1 to N. In some embodiments, it may be desirable to change the delay relationship among compressors in order to follow a moving speaker. An example of a compressor with adjustable constant group delay/delay line, and gain linkage is described in U.S. Pat. No. 7,558,391. Note that not all of the 1 to N Microphone Circuits 1300 outputs need be processed by an associated Multiband Compressor Block. For example, some microphone circuit outputs may be provided directly to the array processor, some may be further processed by compressors, and some may be further processed by Multiband Compressor Blocks. System Operating Parameters 1325 supplies the initial or base Compressor or Multiband Compressor Operating Parameters, which may be different for each compressor, the same for all compressors, or comprise common subsets, where a plurality of compressors have the same compressor operating parameters, Compressor or Multiband Compressor Operating Parameters which include delay parameters to vary the amount of delay, and Bandsplit Filter Operating Parameters.

FIG. 13B shows details of an example of Multiband Compressor Block 1310 and the connections between multiple Multiband Compressor Blocks. Microphone Circuits 1300 outputs 1 to N are provided as inputs to Multiband Compressor Blocks 1310 1 to N, first processed by Bandsplit Filters 1350 1 to N, the outputs of which are provided as inputs to the associated compressors 1 to N in Compressor Blocks 1360 1 to N. In certain embodiments, the outputs of Bandsplit Filters 1350 may bypass the Compressor Block and be provided directly as inputs to Array Processing 1330. Gain Matching links between Multiband Compressor Blocks are also shown. An example representative of a gain matching link of a common frequency band can be seen in the low frequency band Compressor 1 of Compressor Block 1360-1 of Multiband Compressor Block 1310-1 connected by Gain Matching 1320 Band 1, Gain Link 1, to Compressor 1 of Compressor Block 1360-N of Multiband Compressor Block 1310-N and similar Compressor 1's in other Multiband Compressor Blocks 1310 2 to N−1. A similar connection is implemented for Compressors 2 through N. Alternative connections between Multiband Compressor Blocks 1310 1 to N are contemplated including, for example, no gain matching between some frequency bands of Multiband Compressor Blocks, gain matching a subset of Compressors 1 to N between Multiband Compressor Blocks, effectively combining a subset of frequency bands, and gain matching all of Compressors 1 to N between Multiband Compressor Blocks.

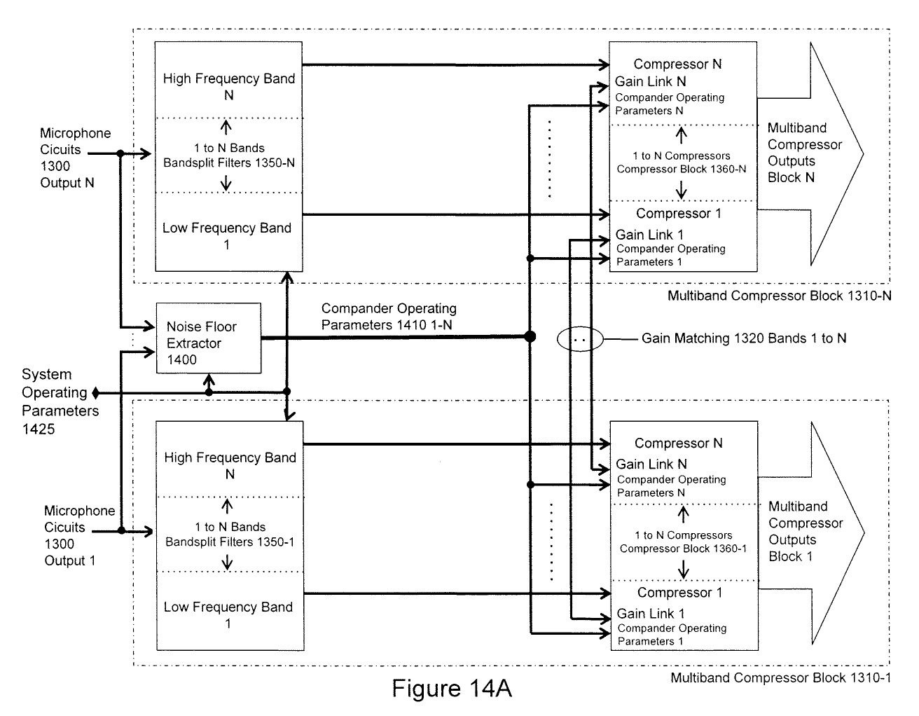

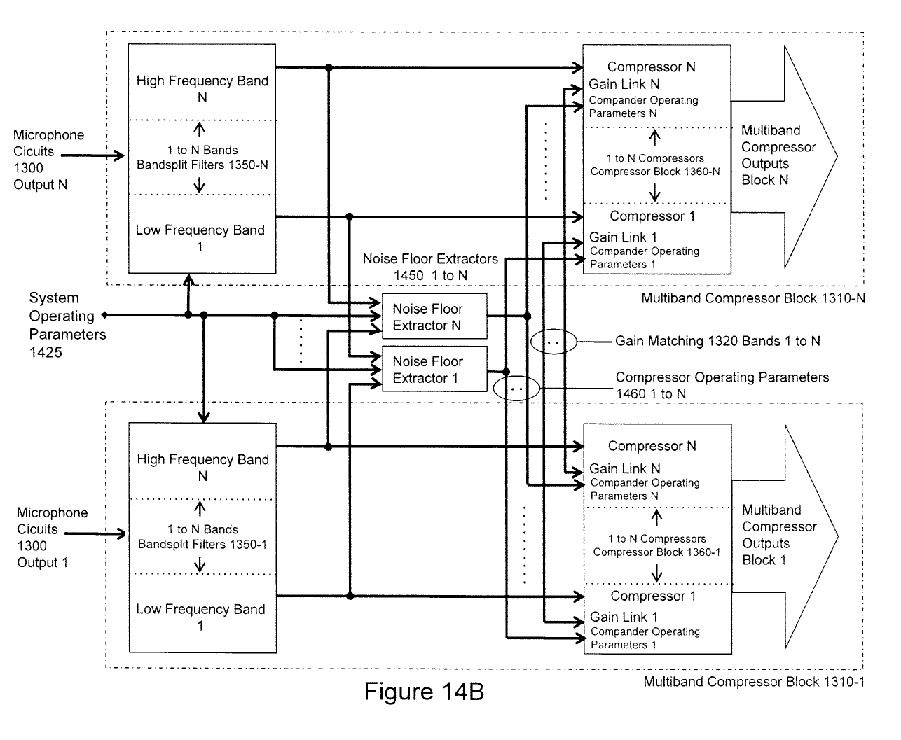

A noise floor extractor may be added to the previously described multiband compressor array. FIG. 14A shows an example in which Noise Floor Extractor 1400 is added to Multiband Compressor Blocks 1310 1 to N. Microphone Circuits 1300 outputs 1 to N are provided as inputs to Noise Floor Extractor 1400 and the determined noise floor, which is typically based on the noisiest input, is used to modify the initial or base Compressor or Multiband Compressor Operating Parameters of System Operating Parameters 1425 to produce, in this example, modified Compander Operating Parameters 1410 1 to N, which are provided as inputs to the compressors in Compressor Blocks 1360 1 to N. In some embodiments, the bandsplit filter outputs may be used as inputs to the noise floor extractor. Note that not all Microphone Circuits 1300 outputs or Bandsplit Filters 1350 outputs are required as inputs to Noise Floor Extractor 1400 and that some frequency bands may not incorporate the Noise Floor Extractor processing. Also note that not all Compander Operating Parameters 1410 1 to N need be modified and that some Compander Operating Parameters 1410 1 to N may be modified in a manner different than other Compander Operating Parameters 1410 1 to N. System Operating Parameters 1425 typically include the Compressor or Multiband Compressor Operating Parameters with optional delay parameters, Noise Floor Extractor Operating Parameters, and Bandsplit Filter Operating Parameters. System Operating Parameters 1425 may supply the initial or base Compressor or Multiband Compressor Operating Parameters to Noise Floor Extractor 1400, which may be different for each compressor, the same for all compressors, or comprise common subsets, where a plurality of compressors have the same compressor operating parameters. The initial or base Compressor or Multiband Compressor Operating Parameters may be modified by Noise Floor Extractor 1400 to produce Compressor Operating Parameters 1410 that are modified in the same manner or differently for each compressor or subset of compressors.

Typically, the background noise level varies with frequency in which case it is desirable to have a noise floor extractor for each bandsplit filter frequency band/compressor.

FIG. 14B shows an example of the addition of Noise Floor Extractors 1450 1 to N to Multiband Compressor Blocks 1310 1 to N. Each Noise Floor Extractor 1450 1 to N receives, as input, the associated outputs of Bandsplit Filters 1350 1 to N, where Noise Floor Extractors 1450 1 to N modify the initial or base Compressor or Multiband Compressor Operating Parameters of System Operating Parameters 1425 to produce, in this example, modified Compander Operating Parameters 1460 1 to N, which are provided as inputs to the compressors in Compressor Blocks 1360 1 to N. For example, the Low Frequency Band 1 outputs of Bandsplit Filters 1350 1 to N may be provided as inputs to Noise Floor Extractor 1 of Noise Floor Extractors 1450, which typically modifies the initial or base Compressor or Multiband Compressor Operating Parameters of System Operating Parameters 1425 to produce modified Compander Operating Parameters 1460-1, which is input to Compressor 1 in Compressor Blocks 1360 1 to N. In a feedback design, the inputs to Noise Floor Extractors 1450 may be provided by the compressor outputs of Compressor Blocks 1360 1 to N. Note that not all Bandsplit Filter or Compressor outputs are required as inputs to the Noise Floor Extractors and that some frequency bands may not incorporate the Noise Floor Extractor processing. In addition, Noise Floor Extractors 1450 may receive as inputs, outputs from multiple bandsplit filter frequency band outputs. System Operating Parameters 1425 typically include the Compressor or Multiband Compressor Operating Parameters with optional delay parameters, Noise Floor Extractor Operating Parameters, and Bandsplit Filter Operating Parameters. System Operating Parameters 1425 supplies the initial or base Compressor or Multiband Compressor Operating Parameters to Noise Floor Extractors 1450 1 to N, which may be different for each compressor, the same for all compressors, or comprise common subsets, where a plurality of compressors have the same compressor operating parameters. The initial or base Compressor or Multiband Compressor Operating Parameters may be modified by Noise Floor Extractors 1450 1 to N to produce Compressor Operating Parameters 1460 1 to N that are modified in the same manner or differently for each compressor or subset of compressors.

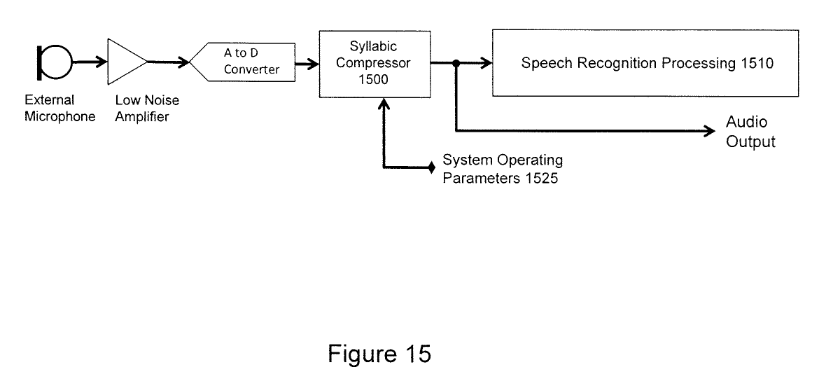

In certain embodiments of the invention, and as noted above, a syllabic compressor is substituted for a typical compressor in order to increase the amplitude of soft speech sounds. This substitution typically improves speech intelligibility for both people and speech recognition systems. FIG. 15 shows an example of a speech recognition system according to certain aspects of the invention, in which a Syllabic Compressor 1500 is used in place of a conventional gain cell. In certain embodiments, the syllabic compressor may precede the analog to digital converter. System Operating Parameters 1525 typically include Compressor Operating Parameters as previously described. Syllabic compressors typically use fast attack and release times to adjust the compressor gain quickly in order to follow the amplitude variations of each syllable in a word, typically 1 mSec for attack and less than 50 mSec for release. If the attack and release times are too slow, the compressor may not react fast enough to amplify the soft speech sound syllables, responding instead to the larger amplitude vowel sounds.

Fast attack and release times typically produce higher signal waveform distortion than slower attack/release times. If the increased distortion associated with the required fast attack and release times for syllabic compression is determined to be undesirable, an adaptive dynamic compander, such as a compander described in U.S. Pat. No. 7,558,391, may be used. In such cases, instant attack and release times may be used without introducing waveform distortion. Typically, the release time is on the order of 50 mSec to produce more natural sounding speech.

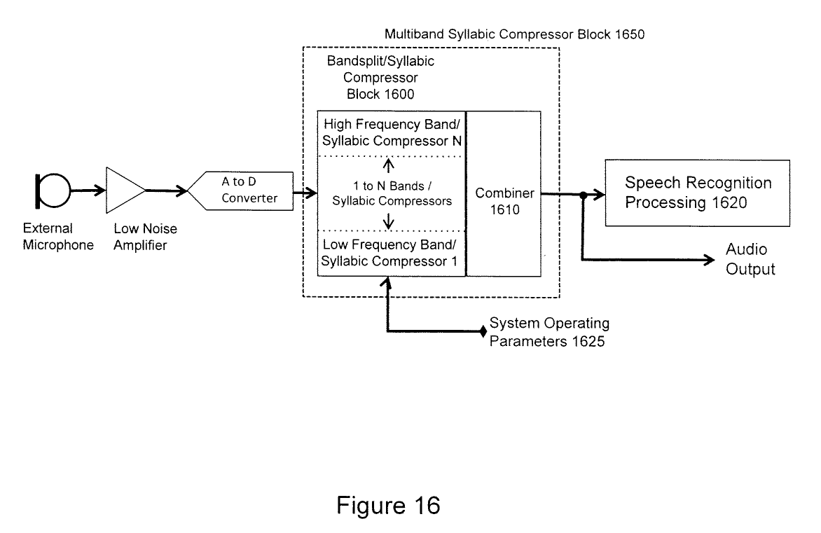

Since a majority of soft speech sounds are associated with high frequency consonant sounds, the syllabic compressor may use multiple frequency band (multiband) processing techniques. FIG. 16 shows an example of a multiband syllabic compressor, where each frequency band includes a compressor (Bandsplit/Syllabic Compressor Block 1600), with the outputs combined into a single output in Combiner 1610, which is provided as an input to Speech Recognition Processing 1620. In some embodiments, the multiband syllabic compressor may precede the analog to digital converter. The higher frequency band or bands and associated compressors, typically above 1 KHz, may be compressed more than the lower, vowel dominated bands, to amplify the soft speech sounds. Alternatively, a compressor may be used in the lower frequency bands where vowel sounds dominate while syllabic compressors are used in the higher frequency bands. In some cases, the bandsplit filter outputs, typically the lower frequency vowel dominated bands, may not use any compression and are directly input to Combiner 1610. System Operating Parameters 1625 supply the Compressor or Multiband Compressor Operating Parameters, which may be different for each compressor, the same for all compressors, or consist of common subsets, where a plurality of compressors have the same compressor operating parameters, and Bandsplit Filter Operating Parameters.

In certain embodiments, the syllabic compressor may use compression limiting. However, compression limiting can result in the noise floor being amplified, with a possible reduction in speech recognition accuracy. For this reason, dynamic range compression may be used (see FIG. 5). Dynamic range compression may also provide an overall automatic gain control for producing consistent speech levels over varying distances from the speaker to the microphone, without amplifying the noise floor.

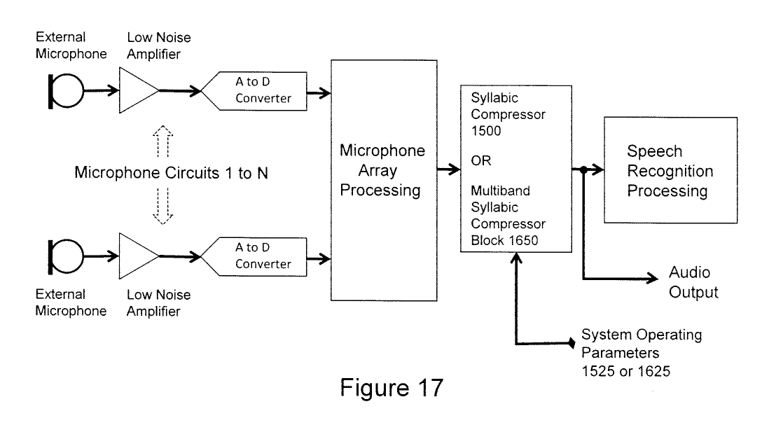

To increase the distance from the speaker to the microphone, microphone array beam forming is typically used to increase the speech signal to noise ratio by reducing the amount of background noise detected away from the speaker. In this case, a wideband Syllabic Compressor 1500 or Multiband Syllabic Compressor 1650 may be used after the array processor (see the example in FIG. 17) in order to amplify the soft speech sounds and produce consistent speech levels over varying distances from the speaker to the microphone array.

The similarities between FIG. 17 and FIG. 10 will be appreciated. However, it will be noted that one difference is use of syllabic compressors in place of compressors. For the examples of embodiments described with respect to FIGS. 8-14B, any compressor may be replaced by a syllabic compressor and a variety of hybrid syllabic compressor/compressor systems may be obtained, as well as fully syllabic compression systems.

Systems, methods, processes and apparatus according to certain aspects of the invention may be embodied in various physical systems. Certain embodiments may be fully implemented using analog hardware and/or digital hardware. It will be appreciated that certain embodiments may be implemented using a hybrid of analog and digital hardware. Furthermore, certain embodiments comprise hardware that includes one or more processors that can be configured to perform certain digital processing functions. Programmable systems can facilitate a reduction in physical space and power requirements and can offer greater flexibility in some applications. For example, programmable systems can be provided that adapt to application needs, allocating resources (e.g. computing cycles, input/output devices) according to changing application needs. Accordingly, certain embodiments employ storage devices encoded with instructions and data that, when executed by one or more processors, perform certain desired functions. Storage can include dynamic memory, static memory, non-volatile memory, including flash memory and read only memory, disk drives, solid state drives and optical storage, or any storage medium suited to an application of the invention. Hardware and software components may be embodied in any of a number of devices, including microphones, amplifiers, mobile communication devices such as cell phones, computers including personal computers, point of sale equipment, cameras, high fidelity sound systems, MP3 players, and so on. It will be appreciated that physical devices may comprise one or more processors including commercially available microprocessors, custom processors and controllers that may be embedded in an ASIC, FPGA or other custom device, digital signal processors, sequencers and reconfigurable analog or digital circuits. Typical applications include systems in which software is executed on a Digital Signal Processor and/or Personal Computer platforms.

It will be appreciated that, while the described systems relate to one or more microphones, the outputs of which may be converted from analog to digital in and ND converter prior to further processing, one or more digitized microphone signals may be provided directly to the system. For example, microphones can include ND converters and signal processing capabilities such that the output of a microphone is provided in a digital signal that can be transmitted using a digital bus or digital communications channel. The use of digital inputs enables certain embodiments to process signals from remote microphones. Communication of the digitized output of microphones may be provided using, for example, Universal Serial Bus (USB), Firewire, S/PDIF (optical or RF), HDMI, DisplayPort, MADI (Multichannel Audio Digital Interface), McASP, 12S, and PCI, Ethernet and/or wireless interfaces such as WiFi, WiMAX, Bluetooth, Zigbee or any custom or future digital bus, wireless or optical interface.

### ADDITIONAL DESCRIPTIONS OF CERTAIN ASPECTS OF THE INVENTION

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide arrays of one or more compressors. Some of these embodiments comprise a digitizer that generates a digitized signal representative of an audible input and a configurable compressor that compresses the digitized signal, wherein the compressed signal is provided to a speech recognition system. Some of these embodiments comprise a microphone for detecting the audible input and for providing an input signal to the digitizer. In some of these embodiments, a compression ratio of the compressor is configurable. In some of these embodiments, attack and release times of the compressor are configurable. In some of these embodiments, at least one kneepoint of the compressor is configurable. In some of these embodiments, at least one threshold of the compressor is configurable. In some of these embodiments, the compressor comprises a plurality of compressors, each of the plurality of compressors operates within a selected band of frequencies. In some of these embodiments, each of the plurality of compressors is configured independently from the other compressors.

Some of these embodiments comprise a plurality of microphones, each microphone providing an input signal that is digitized and provided to a corresponding one of the plurality of compressors. In some of these embodiments, at least one configurable setting of each of the plurality of compressors is coordinated with a corresponding setting of another of the compressors. In some of these embodiments, the at least one configurable setting includes a gain setting and is coordinated with the corresponding setting of the another setting to obtain gain matching of the plurality of compressors. In some of these embodiments, the system is embodied in a speech recognition system. According to certain aspects of the invention, the system can be embodied in a speech recognition system that may use syllabic compression.

In some of these embodiments, microphone array beam forming is used. In some of these embodiments, beamforming is provided in a manner that increases audio source signal to noise ratio. In some of these embodiments, the distance between the audio source and the microphone may be increased by reducing the amount of background noise detected away from the audio source. Some of these embodiments comprise a delay buffer to steer the beam. Some of these embodiments comprise a delay buffer to electrically increase the distance between two or more microphone elements to produce a narrower beam.

In some of these embodiments, one or more of a plurality of microphone outputs is processed through a compressor. In some of these embodiments, each of the one or more microphone outputs is associated with an associated compressor. In some of these embodiments, an output of each associated compressor is provided to an array processor. In some of these embodiments, the array processor performs beamforming calculations. In some of these embodiments, low level sounds in the one or more microphone outputs are amplified, thereby optimizing beam forming calculations for low level sounds. In some of these embodiments, the one or more microphone outputs provide far and soft sound inputs. In some of these embodiments, at least some of the plurality of microphone outputs bypass compressors associated with the at least some microphone outputs. In some of these embodiments, the at least some microphone outputs provide near and loud sound inputs. In some of these embodiments, the far and soft sound inputs and the near and loud sound inputs are processed to obtain a distance estimate to the sound source.

In some of these embodiments, at least one of the compressors has a constant group delay. In some of these embodiments, at least one of the compressors has a linear phase response, which does not modify the phase of the received microphone signals. In certain embodiments, the compression gain of two or more compressors is linked and/or matched to maintain relative amplitude relationships among the microphones. In some of these embodiments, the beam follows a moving speaker. In some of these embodiments, the beamwidth is changed by electrically modifying the distance between two or more microphone elements providing the plurality of microphone inputs.

Certain embodiments of the invention provide a combination of hardware and software that performs a plurality of functions according to certain aspects of the invention. Some of these embodiments comprise one or more processors including commercially available microprocessors, custom processors and controllers that may be embedded in an ASIC, FPGA or other custom device, digital signal processors, sequencers and reconfigurable analog or digital circuits. In some of these embodiments, instructions and data are maintained in storage wherein the instructions, when executed by the one or more processors, cause the one or more processors to perform the plurality of functions.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A system comprising:
an array of one or more configurable compressors, each configurable compressor receiving a digitized signal representative of an audible input, each configurable compressor providing a compressed signal as an output;
a digitizer that provides the digitized signal to one of the one or more configurable compressors.

2. The system of claim 1, further comprising a microphone for detecting the audible input and for providing an input signal to the digitizer.

3. The system of claim 2, wherein the one or more configurable compressors comprises a syllabic compressor and wherein the compressed signal is provided to a speech recognition system.

4. The system of claim 3, wherein a plurality of parameters controlling operation of each syllabic compressor is configurable, the plurality of parameters including two or more of a compression ratio, attack and release times, a kneepoint and a threshold.

5. The system of claim 1, wherein the or more configurable compressors comprise a plurality of compressors, each of the plurality of compressors operates within a selected band of frequencies.

6. The system of claim 5, wherein each of the plurality of compressors is configured independently from the other compressors.

7. The system of claim 5, further comprising a plurality of microphones, each microphone providing an input signal that is digitized and provided to a corresponding one of the plurality of compressors.

8. The system of claim 7, wherein at least one configurable setting of each of the plurality of compressors is coordinated with a corresponding setting of another of the compressors.

9. The system of claim 8, wherein the at least one configurable setting includes a gain setting and is coordinated with the corresponding setting of the another setting to obtain gain matching of the plurality of compressors.
